(19) United States
(12) Patent Application Publication
(10) Pub. No.: US 2025/0377010 A1
(43) Pub. Date: Dec. 11, 2025

(54) CRANKSHAFT FOR AN INTERNAL COMBUSTION ENGINE

(71) Applicant: Kurt Imren YAPICI, Eschweiler (DE)

(72) Inventors: Kurt Imren YAPICI, Eschweiler (DE); Dominik PENNINGS, Aachen (DE)

(73) Assignee: Kurt Imren YAPICI, Eschweiler (DE)

(21) Appl. No.: 19/227,701

(22) Filed: Jun. 4, 2025

(30) Foreign Application Priority Data
Jun. 5, 2024 (DE) 10 2024 001 810.7

(51) Int. Cl. F16C 3/10

(52) U.S. Cl. CPC F16C 3/10

(57) ABSTRACT

The invention relates to a crankshaft for an internal combustion engine. In particular, the invention relates to a crankshaft having at least one crankshaft segment, comprising at least one disk-shaped crank web, arranged with rotation symmetry relative to a crankshaft axis and carrying a main bearing surface that rotates around a crankshaft axis, and a crank pin that is arranged eccentric to the crankshaft axis and extends parallel to the crankshaft axis.

### CROSS REFERENCE TO RELATED APPLICATIONS

This application is a U.S. application that claims priority under 35 U.S.C. 119 from DE 10 2024 001 810.7 filed on Jun. 5, 2024.

### BACKGROUND OF THE INVENTION

The invention relates to a crankshaft for an internal combustion engine. In particular, the invention relates to a crankshaft having at least one crankshaft segment, comprising at least one disk-shaped crank web, arranged with rotation symmetry relative to a crankshaft axis and carrying a main bearing surface that rotates around a crankshaft axis, and a crank pin that is arranged eccentric to the crankshaft axis and extends parallel to the crankshaft axis.

A reduction of the specific engine weight in the case of internal combustion engines is of great importance in mobile applications, since in this way less engine power needs to be used for transport of the drive unit, which power can alternatively be used for more load capacity, greater acceleration capacity or more comfort measures.

It is understood that the inherent weight of the engine plays a significant role, specifically in aviation. Since diesel engines have clearly higher cylinder pressures in comparison with gasoline engines, the design must be configured for significantly greater forces. The greater forces that occur within the design lead to thicker wall thicknesses, greater bearing dimensions, and larger and often also more numerous screw connections. All of these measures bring about an increase in the engine weight relative to gasoline engines having the same power. The high specific engine weight is the main barrier for widespread use of diesel engines in aviation, although replacement of gasoline engines with diesel engines would be a great advantage, since these are generally more cost-effective and can use jet fuels that are available at all airports. It is understood that a lower engine weight, also in the case of all other mobile applications, represents a great advantage.

### SUMMARY

The set of problems involving higher engine weight also applies to many gas engines and to the use of other fuels, particularly anti-knock fuels, and combustion methods in which clearly higher cylinder pressures are achieved than in gasoline operation. It is the task of the invention to be able to represent a particularly light engine construction that simultaneously allows very long-lived and economical operation with low fuel consumption. For reasons of long life and the low consumption being aimed at, concepts involving high speeds of rotation are eliminated for improving the power to weight ratio.

The invention refers back to an old but proven engine design and is based on the use of a disk crankshaft having a tunnel crankcase. In contrast to existing engines having a disk crankshaft, the crankshaft is composed of segments that have a hollow structure, wherein the division is situated in the region of the main bearings. The divided design facilitates the production of a hollow structure, and allows particularly thin wall thicknesses as well as great freedom of design in terms of geometry.

Thus, a crankshaft segment that comprises at least one disk-shaped crank web arranged with rotation symmetry relative to a crankshaft axis and carrying a main bearing surface that rotates around a crankshaft axis, and a crank pin that is arranged eccentric to the crankshaft axis and extends parallel to the crankshaft axis, wherein a depression that is set back axially in the direction of the crankshaft axis is provided on the side of the crank web that faces away from the crank pin.

Furthermore, screw-connection openings can be arranged in screw groups, in the aforementioned crankshaft segment, also in the crank web, with a rotation symmetry of 60°, wherein one of the screw groups is arranged at the level of the crank pin.

By means of the simple geometry of the crankshaft segments, production of unmachined parts is possible both by means of coreless casting or forging. Since the division lies in the main bearings, which have very large diameters in the case of disk crankshafts, a screw connection that withstands great stresses is possible at the parting surfaces. For reasons of production technology, it is a good idea to integrate the contact surfaces of the screw connection into the lathing machining of the large end bearings. Alternatively, machining can also take place with a fold-out conical miller, through the screw hole, by pull. The latter method is connected with greater effort, but it allows a greater distance of the screw heads from the cylinder axis as the result of the milling process, and thereby more construction space is available for the connecting rods, and the reliability of preventing bending can be increased.

It has been shown that it is disadvantageous if two screw heads stand opposite one another at both ends in a segment, since this can limit the maximal screw length and thereby the usable thread length. In this regard, a remedy can be created by means of an angle-offset hole circle at both ends, wherein this would lead to more variants in the cast parts and possibly to less advantageous screw positions. In the case of some engines, such as, for example, six-cylinder boxer engines, there is no overlap of the projected large-end diameters in the crankshaft axis direction. It has been shown that in the case of these engines, this set of problems can be circumvented. For reasons of strength, as many screws as possible should be arranged in the region of the crank pins, something that would be hindered by an angle offset of the hole circles. In the case of the engines described, the screws should be arranged, in the case of six crank pins, in groups of six, for example, wherein each group of six, offset by 60°, has the same arrangement, and in one group, all the screw positions lie within the projected crank pin diameter. With this principle, a very reliable connection of the crankshaft segments is guaranteed, wherein identical casting or forging blanks can be used for the segments. The offset by 60° makes it possible that the screws of a group always lie within the projected crank pin diameter of the following segment. In order to avoid restrictions with regard to the cylinder distance, it must be avoided, in this regard, as mentioned above, that two screw heads stand directly opposite one another in a segment. The arrangement of the screws is therefore selected in such a manner that they always point, with their shaft, in the direction of the crank pin within the projected bearing diameter of which they lie.

The parting surfaces of the crankshaft segments do not have to be configured to be planar, but rather can also be connected to one another with shape fit, for a secure flow of force. An advantageous embodiment is, in this regard, a construction of the parting surface that can take place with lathing that takes place centered relative to the crankshaft axis. In this regard, the surfaces are structured in such a manner that at least one circumferential depression is provided on a segment, into which depression at least one circumferential elevation of the neighboring segment engages with shape fit.

Due to the hollow embodiment, a central oil feed into the crankshaft is possible (preferably at the end that does not deliver power), wherein the oil is passed through the crankshaft to the large end bearings and, if applicable, also to the main bearings. The design freedom that results from the division also allows integrating additional separate oil lines, for example for the propeller adjustment.

For example, it is possible to delimit a closed region central to the crankshaft axis, which region overlap with the projected large end bearing diameters. This region can preferably be configured to be round or a polygon, wherein in the latter case, the number of corners should agree with the number of crank pins, so that the corners coincide with the connected segments. Outside of this separated region, the oil for supplying the large end (and, if applicable, also the main bearings) is conducted, while within this region, the oil for other tasks, such as for example, propeller adjustment is conducted. If the hydraulically separated region is used for oil feed of a propeller adjustment, a hydraulic piston and a piston spring can be arranged, according to the invention, in the crankshaft end that is oriented toward the propeller, which piston, in the manner of hydraulic cylinders usually arranged in the propeller hub, takes on the propeller adjustment.

It is understood that in this regard, the piston force must be conducted to the adjustment propeller mechanically, for example by means of a bar that is concentric to the crankshaft axis. This bar moves in a direction (preferably toward the propeller) due to the oil pressure, and back in the other direction due to the aforementioned piston spring. The advantage of this solution as compared to integration of the hydraulic piston into the adjustment propeller lies in the weight savings, on the one hand, since no additional hydraulic cylinder needs to be used, and, on the other hand, in the possibility of being able to remove the propeller without contamination due to hydraulic oil.

The divided configuration also allows easy installation of raceways on the main bearings. In this regard, borders can be provided on the crankshaft segments, which borders fix the raceways in place axially and additionally can serve as an axial guide for a roller bearing.

As an alternative to roller bearings, the main bearings of the crankshaft can also be slide-mounted. Slide bearings have the advantage of being significantly less expensive and able to withstand greater stress, but they have the disadvantage of greater friction force. Since the friction force increases to the third power with the diameter, this is particularly disadvantageous in the case of the large bearing diameters of a disk crankshaft. In order to limit the friction losses to reasonable values in spite of slide bearings, floating rings can be arranged between the bearing surfaces of the housing and those of the shaft, which rings are slide-mounted on their inside toward the shaft, and are slide-mounted on their outside toward the housing. During a rotation of the crankshaft, these rings rotate at about half the crankshaft velocity due to their dual slide-mounting, and thereby, as the result of the reduced relative movement, the friction force is approximately cut in half.

It has been shown that the region of the crank pin is the most critical region with regard to the stresses that occur. In the case of the hollow disk crankshaft, great stress peaks can occur, in particular within the closed-off cavities. In order to reduce the stresses, a bulkhead wall can be provided within the crank pin, which is configured to be hollow, to a great extent. This bulkhead wall runs perpendicular to the crank pin axis to a great extent, and thereby the deformation of the crank pin is reduced, and the great gas pressure forces are directly conducted from the outer crankshaft region to the center.

A particularly advantageous configuration of the bulkhead wall is achieved if this wall has a variable thickness, which becomes greater with an increasing distance from the crankshaft axis. For obvious reasons, the bulkhead wall should not hinder the oil flow within the crankshaft, in the axial direction; for this reason, perforations for the oil line must be provided within the crank pin.

It has been shown that these perforations preferably should not lead through the bulkhead wall, so as to prevent stress peaks. In the case of a particularly advantageous embodiment, the crank pin essentially consists of a thick-walled cylinder having the bulkhead wall in the middle. For the oil line, one or better multiple bores for the oil line are provided within the thick, cylindrical crank pin wall. At the exit openings of these oil lines, potentially high stresses can occur; in order to reduce these, it has proven to be advantageous to provide an exit hill with approximately rotation symmetry relative to the bore axis, and thereby the perforation of the bore takes place at a low-stress location.

The oil lines described can also be utilized to supply oil to the large end bearing locations, by means of a bore that runs radially, at least in part, and touches on the oil lines. On the basis of the relatively large inside volume of the hollow crankshaft, the oil pressure buildup can be delayed after a start. One possibility of preventing this is the use of fill bodies in the cavities, which fill these as completely as possible without hindering the oil flow. It is understood that for this purpose, low-density materials such as polyamide or lithium/magnesium alloys should be used, for example. It is also conceivable to make the fill bodies hollow and to fill them with a low-density liquid.

Furthermore, it has proven to be advantageous to increase the wall thicknesses in the main bearing region, toward the crank pin, so as to guarantee low-stress transfer of force from the crank pin into the main bearing region.

A further special feature according to the invention is the extensively closed configuration of the crankcase. For an improved flow of force of the gas forces between cylinder head and main bearings, the invention refrains from providing large openings in the direction of the oil pan. The oil separation preferably takes place by means of multiple small bores or multiple slits per crank pin, in the manner of an oil scraper as used in dry sump lubrication.

The orientation of these oil discharge openings takes place, as in the case of dry sump lubrication systems, primarily tangentially, wherein the oil is flushed into the openings by means of the rotation of the crankshaft and the movement of the connecting rods, without any strong change in direction. In contrast to disk crankshaft engines according to the state of the art, conventional installation of the connecting rods from “below”, i.e., from the direction of the oil pan, is no longer possible when using divided slide bearing connecting rods. In the case of engines having high combustion pressures, a straight divided connecting rod can generally not be introduced through the cylinder, since the dimensions in the region of the divided large end bearing no longer fit through the cylinder bore.

It is therefore particularly advantageous if a divided connecting rod is characterized by a connecting rod eye composed of a bearing lid and a center part, both of which are connected to form the connecting rod eye, as well as by an upper part that forms a connecting rod bar, which part is connected to the center part.

In the case of a slanted division, it is true that the connecting rod could be passed through the cylinders, but tightening of the connecting rod screws would hardly be possible at all, or could be performed only in a very complicated manner, due to the extensively closed configuration of the crankcase. The use of a separate cylinder liner, which is inserted after installation of connecting rod and piston, would provide a remedy, but would conflict with the goal of a particularly light construction, since for this purpose the cylinder spacing and thereby also the engine weight would have to be increased.

In the case of engines having only one row of cylinders and V-engines, it is conceivable to construct the connecting rod screws with an orientation of the screw head toward the piston, as it frequently takes place in the case of boxer engines. If the method of construction according to the invention is supposed to be combined with the boxer method of construction, then the problem arises, in the case of small cylinder distances, that the connecting rods, at bearing dimensions selected in a technically reasonable manner, no longer fit through between the main bearings with the bearing locations. For assembly reasons, a three-part configuration must be used.

Three-part connecting rods are state of the art in large engines, and in this regard, aside from the conventional separation around the large end on the crankshaft side, an additional separation location is created in the shaft. According to the invention, the large connecting rod eye without the shaft is mounted first on the related large end bearing journal. In this regard, the connecting rod geometry is designed, according to the invention, in such a way that, in at least one position, preferably oriented with the shaft axis toward the crankshaft axis, the point farthest away from the crankshaft axis lies within the projected circular surface area of the inside diameter of the main bearings. If all the connecting rods are pre-mounted oriented in this manner, they can thereby be pushed into the undivided crankcase, together with the crankshaft. Without the assembly method according to the invention, assembly of the connecting rods would be almost impossible, since the individual connecting rod components would only be accessible through the cylinder bore and the slit between the main bearings. The complex assembly process would have to be carried out without sufficient accessibility.

With the method proposed according to the invention, the connecting rod shaft can be installed through the cylinder bore after introduction of the crankshaft into the tunnel housing. It is understood that the pistons can only be installed in a further step; for this purpose, a continuous assembly bore is provided for the piston pins, parallel to the crankshaft axis in the region of the lower dead points of the piston pins. This step corresponds to the state of the art in the case of many boxer engines.

In this regard, it is furthermore advantageous for a disk crankshaft if the arrangement, ready for assembly, of a crankshaft configured as a disk crankshaft, as well as comprising disk-shaped crank webs arranged with rotation symmetry relative to a crankshaft axis and carrying a main bearing surface that rotates about a crankshaft axis, and crank pins arranged eccentrically relative to the crankshaft axis extending parallel to the crankshaft axis, with bearings set onto the crank webs, which bearings have an outside bearing diameter, as well as connecting rod eyes that are arranged on the crank pins, is characterized in that the connecting rod eyes are arranged radially within a cylinder surface spanned by the outside diameters of the bearings.

Three-part connecting rods are fundamentally not a new invention, but rather are frequently used in large engines, so as to facilitate the installation/removal of pistons. In these engines, the connecting rod shaft is generally configured with a circular cross-section and fastened to the connecting rod foot with four or more screws. The parting surface is configured as a plane in the force-conducting region, aside from centered areas. The method of construction of three-part large engine connecting rods cannot easily be applied to the engine according to the invention. Because of the small construction length that is required in the longitudinal direction of the engine, the connecting rod shaft must possess clearly larger dimensions in transverse directions of the engine than in the longitudinal direction of the engine. Also, the design freedom for the placement of the connecting rod screws at this parting location is limited due to the required small construction length. An embodiment in which the connecting rod shaft widens toward the connecting rod foot and is fastened to the connecting rod foot with two screws, in the widened region, is therefore preferred. These screws are arranged, preferably symmetrical to two planes of symmetry of the connecting rod, once through the axes of the large and the small connecting rod eye, and once perpendicular to them.

It is understood that the screws are moved so far apart, in this regard, that no weakening of the shaft cross-section is required. The arrangement of screws and parting surfaces described here can be easily understood for technical reasons and has certainly already been carried out in a similar form. It has been shown, however, that a planar configuration of the parting location in the shaft region is disadvantageous, since a loss of contact, in phases, can occur in the connecting rod center, under tensile stress, due to the great distance of the screws from one another. Also, the risk exists that forces transverse to the screw axis direction can occur under tensile stresses at the parting surface, which forces can cause partial sliding of the parting surfaces. Both of these described effects are undesirable and endanger the operational reliability of the connecting rod.

According to the state of the art, parting surfaces in connecting rods are frequently produced with tooth mechanisms or other shape-fit geometries (for example fractured surfaces in the case of a fractured connecting rod). Such a configuration according to the state of the art could allow reliable protection against sliding of the parting surfaces at this parting surface, but not against cyclical partial loosening and re-application. Connecting rod parting surfaces with tooth mechanisms or fractured surfaces are always structured along a plane as the basic geometry, according to the state of the art. According to the invention, a different configuration of the parting surface is proposed.

It has been shown that an embodiment is preferred in which, in a constant progression, an approximation of the parting surface to an imaginary plane through the axis of the large connecting rod eye and perpendicular to the connecting rod axis in the direction of the connecting rod center takes place. This parting surface progression redirects the screw forces, at least in part, into a force component to the connecting rod center and to the connecting rod axis. With this parting surface geometry, not only sliding of the parting surfaces but also partial cyclical loosening can be prevented. The simplest form of such a parting surface is an arc-shaped configuration, in which the center axis of the arc intersects the connecting rod axis perpendicularly. It is immediately evident that such a parting surface does not require any great production effort, and does not set any special conditions regarding the material resilience, as it is required in the case of a fracture-separated connecting rod. It is also conceivable to configure the parting surface spherically, so as to allow lathing of the surfaces, for example.

Crankcases configured as tunnel crankcases furthermore offer other advantages, if the crankcase has a corrugated pipe structure and/or if the water mantle extends beyond the region required for cooling, in the direction of the crankshaft axis.

The tunnel crankcase has a cylindrical axis, a crankshaft axis, and a surface for attaching a cylinder head, in this regard. In this regard, the crankcase has raceways, usually arranged coaxial to the crankshaft axis, comprises a water mantle, which is delimited, in the direction of the cylinder axis, toward the inside, by a cylinder wall, and has a wall structure toward the outside.

Tunnel crankcases offer a great potential for saving weight, because, in this regard, bulkhead walls, main bearing screw connections, bearing lids/bed plates and the like are eliminated. In combination with boxer engines, the usual division of the crankcase through the crankshaft axis, perpendicular to the cylinder axes, is also eliminated, and thereby numerous screw-connection points are eliminated, and significant weight can be saved.

It has been shown that in the design, the region in which the cylinders make a transition into the region of the crankshaft bearings, in particular, is critical for the stress. In order to guarantee the goal of as light an engine as possible, extensive ribbing of the crankcase, to relieve stress on this transition, is not a desirable option.

According to the invention, instead, a water mantle extended beyond a region necessary for cooling is provided on the cylinders, which mantle widens in the direction of the main bearing area and is separated, downward, from the main bearings and the space for the connecting rod range of motion only by a thin wall thickness (in the range of 3 to 8 mm). In this regard, water mantle is understood to be a common term that is also used for other liquid coolants or mixtures of water and other ingredients. The outer delimitation of the water mantle is part of the supporting structure of the crankcase and passes the gas forces into the bearing structure harmonically, by means of the widening toward the main bearings. This design principle is in complete contradiction to light-construction approaches according to the state of the art, in which the length of the water mantle is kept as short as possible so as to save weight. The outer delimitation of the water mantle, in the case of engines according to the state of the art, only happens to have a supporting function, and, in the case of light-construction crankcases with separation of the functions carrying/sheathing by means of two different materials, is always produced from the lighter but mechanically less stress-resistant material.

In the case of the method of construction according to the invention, the outer sheath of the crankcase is also the supporting structure, since the usual inner structures such as bulkhead walls, tie rods for the main bearing screw connections, screw shanks, ribs, etc. are eliminated. It has been shown that the most advantageous embodiment of the crankcase is achieved if the cylinders, with the outer water mantle, follow the crank bearing structure downward, in the manner described above, with a large radius. The bearing structure is advantageously configured in the manner of a corrugated pipe, in which the small diameter regions hold the main bearings toward the inside, and the large diameter regions create sufficient space for the connecting rod range of motion. The corrugated pipe structure is extensively closed and possesses perforations for the connecting rods toward the corresponding cylinders as a single larger opening in the inner oil space of the crankcase. The corrugated pipe structure increases the rigidity of the crankcase and thereby allows doing without reinforcement ribs.

In order to achieve an extensively constant bearing play of the main bearings, which are large in the case of disk crankshafts, casting materials on an iron basis are preferably provided for the crankcase. In spite of the high density, light designs are possible with these materials, on the basis of their high specific strength values, by means of the principle according to the invention.

It is understood that when using high-density crankcase materials, a high level of integration of functions into the crankcase should not be aimed at for weight reasons. Therefore, the crankcase is kept as simple as possible, wherein additional functions such as attachment and drive of the secondary assemblies, oil distribution, camshaft mounting, engine bearing attachment are moved into components that are attached to the crankcase. A combination of the method of construction according to the invention with two-cylinder benches and a central camshaft that lies at the bottom has proven to be particularly advantageous. In this connection, “lies at the bottom” is understood to mean in the preferred installation and operating position below the crankcase. In this regard, the camshaft is mounted in a camshaft bearing housing that is attached to the crankcase from below.

The oil discharge from the crankcase as mentioned above can be captured, in this regard, by the camshaft bearing housing. It is understood that this camshaft bearing housing can be structured, for weight reasons, from a material having a clearly lower density than cast-iron materials. The camshaft bearing housing can also take on other tasks, such as, for example, guidance of the cam followers (tappets) and oil distribution over one or more oil galleries in the longitudinal engine direction. Furthermore, the camshaft bearing housing can also be used for connecting to the oil pan. In this regard, the oil that exits from the crankcase first runs through the camshaft bearing housing and thereby lubricates the pickup of the cam followers at the camshaft before it gets into the oil pan.

In the case of tunnel crankcases and roller-mounted main bearings, it makes sense to produce inner and outer bearing rings of the roller bearing as individual parts and to mount them into the crankcase (outer) or onto the crankshaft, as applicable. In the case of engines constructed with tunnel housings, the possibility has already been utilized of providing a circumferential groove in the outer bearing ring (alternatively in the bearing seat), so as to be able to use it for passing the oil on. It has been shown that in the case of the method of construction according to the invention, in the boxer engine version, a very advantageous possibility for forming oil spray nozzles exists by means of these oil grooves. In this regard, no extra component is needed for the oil spray nozzles, since these can be formed by means of a connecting bore between the working cylinders and the grooves. Since this connecting bore can be very short (it is only necessary to perforate the wall thickness at the location in question), they can be efficiently produced, as an alternative to drilling, also by means of erosion.

Also, it is easily possible to introduce multiple such bores per cylinder, so that sufficient cooling of diesel pistons without a piston cooling channel can be ensured when using four bores. Since, according to the invention, the camshaft bearing housing can also contain the main oil gallery, i.e., the main oil galleries, oil supply to the circumferential grooves can take place from the oil galleries, through bores into the circumferential grooves.

It is known that diesel engines have clearly higher torque peaks than gasoline engines, due to the high compression ratio and the high peak pressures at the same power and number of cylinders. The propeller stress is increased due to the torque peaks, and this can be problematic, in particular, in the case of a direct drive and a low number of cylinders. Adjustable propellers according to the state of the art consist of a hub in which the propeller blades are mounted to rotate, so as to actively be able to set them to the desired gradient value. For aerodynamic reasons, the propeller hub is generally provided with a propeller covering (cowling).

This cowling is a body shaped in a flow-advantageous manner, which guides the air around the hub and is provided with passage openings for the propeller blades. The cowling is attached to the propeller hub according to the state of the art, and does not take on any kind of supporting function.

The torque peaks described bring about a bending torque of the propeller blades, which are firmly clamped in place on the hub. The outermost clamping in the hub and the propeller diameter determine the free bending length, in this regard, which is critical with regard to the maximal bending stress and inherent bending frequency.

Since the propeller blades are mounted so as to rotate in the hub, their cross-section changes from the wing profile, in the aerodynamically effective outer part, to a circular cross-section toward the hub. In order to keep the holders and the hub weight as small as possible, the cross-section directly at the bearing locations is dimensioned to be as small as possible, wherein generally, no safety reserves for a diesel aircraft engine having the same power are left here.

According to the invention, mounting of the propeller blades is supposed to be improved to such an extent that the vibration sensitivity of the propeller blades is reduced to such an extent, without a noticeably increased weight and without increasing the size of the propeller hub, that operation with a diesel engine is non-critical. In this regard, the cowling is no longer supposed to have a purely aerodynamic function, but rather to offer additional bearing locations for the propeller blades. In this regard, the mounting in the hub remains extensively unchanged, because the cowling is only supposed to be used for radial mounting, while the very great axial forces (due to the centrifugal force) are supposed to continue to be absorbed by the hub.

It is understood that in this regard, on the propeller blades, in the region where they pass through the cowling, a cylindrical region for mounting must be present, at least in certain sections. This cylindrical region is mounted in a corresponding bearing location in the cowling.

The cowling must be connected to the crankshaft in a torsionally rigid manner, so as to be able to take on the bearing function; in this regard, it can be attached to the hub in a conventional manner. If the engine has a conventional starter ring at the power take-off end, it is possible to attach/mount the cowling on the starter ring of the engine, thereby guaranteeing a particularly rigid connection.

The bearing location in the cowling can be structured as a non-lubricated slide bearing, since during the period of use, a change in the angle of attack will take place only occasionally, so that only little wear occurs. The plastic bearing can be provided with vibration-damping properties.

In summary, there is disclosed a connecting an adjustable propeller to a crankshaft end piece, where the propeller hub is attached to a crankshaft end or to the starter ring, but which allows for the adjustment mechanism of the propeller to be completely arranged within the hub. There is also disclosed a propeller covering is used, which is connected to the crankshaft in a torsionally rigid manner, and has an additional mounting of the propeller blades, on which the propeller blades are radially mounted about their adjustment axis.

It is also advantageous if a crankshaft end piece is structured to be hollow and forms a hydraulic cylinder with its interior, the oil feed of which cylinder takes place through the crankshaft segments that are configured to be hollow, from the opposite crankshaft end piece, and has a hydraulic piston in the interior of the cylinder, which piston can be displaced in the axial direction by means of the oil pressure, and the movement of which piston is utilized to adjust the gradient of a propeller.

An advantageous crankshaft segment also occurs if this segment comprises at least one disk-shaped crank web that is arranged with rotation symmetry relative to a crankshaft axis, and carries a main bearing surface that rotates about a crankshaft axis, and a crank pin that is arranged eccentrically relative to the crankshaft axis and extends parallel to the crankshaft axis, which pin is characterized in that the crank pin has a border that acts axially as a contact surface, and runs radially around the crank pin, wherein the border rotates by less than 360°.

In conclusion, it should be mentioned that a crankshaft segment is advantageous if it comprises at least one disk-shaped crank web that is arranged with rotation symmetry relative to a crankshaft axis and carries a main bearing surface that rotates around a crankshaft axis, and a crank pin that is arranged eccentrically relative to the crankshaft axis and extends parallel to the crankshaft axis, which crank web is characterized by a bearing ring, wherein the bearing ring has an inner sliding surface on a side that lies radially inside, and an outer sliding surface on a side that lies radially outside, so that the inner sliding surface forms a slide bearing with the main bearing surface of the crankshaft segment, and the outer sliding surface forms a slide bearing with a bearing seat of a crankcase, in each instance.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 a crankshaft having multiple crankshaft segments;

FIG. 2 a crankshaft segment of the crankshaft according to FIG. 1 in a second view;

FIG. 3 a crankshaft segment according to FIG. 2, in section,

FIG. 4 a sectional view through the center of the main bearing and perpendicular to an imaginary plane through the main bearing axis and large end bearing axis,

FIG. 5 an approximately isometric view of the crankshaft segment,

FIG. 6 a crankshaft segment having a border according to the invention,

FIG. 7 a connecting rod for the crankshaft according to FIG. 1,

FIG. 8 the connecting rod according to FIG. 7 in section,

FIG. 9 the crankshaft segment and the connecting rod in section,

FIG. 10 a crankcase in section,

FIG. 11 the crankcase according to FIG. 10 in a further section,

FIG. 12 a raceway of the crankshaft according to FIG. 1,

FIG. 13 a crankcase in section,

FIG. 14 a propeller connected to the crankshaft according to FIG. 1,

FIG. 15 the propeller according to FIG. 14 in another view,

FIG. 16 a propeller blade of the propeller according to FIG. 14,

FIG. 17 a bearing ring according to the invention, having two sliding surfaces, and

FIG. 18 a further bearing ring according to the invention.

### DETAILED DESCRIPTION

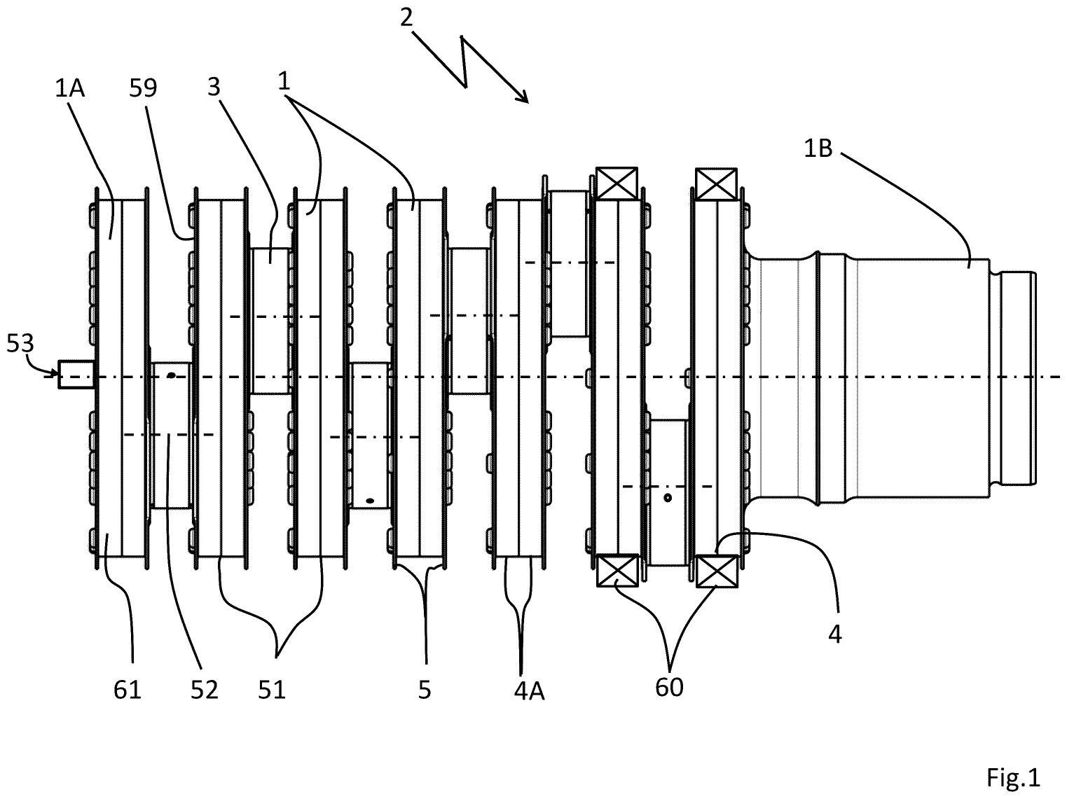

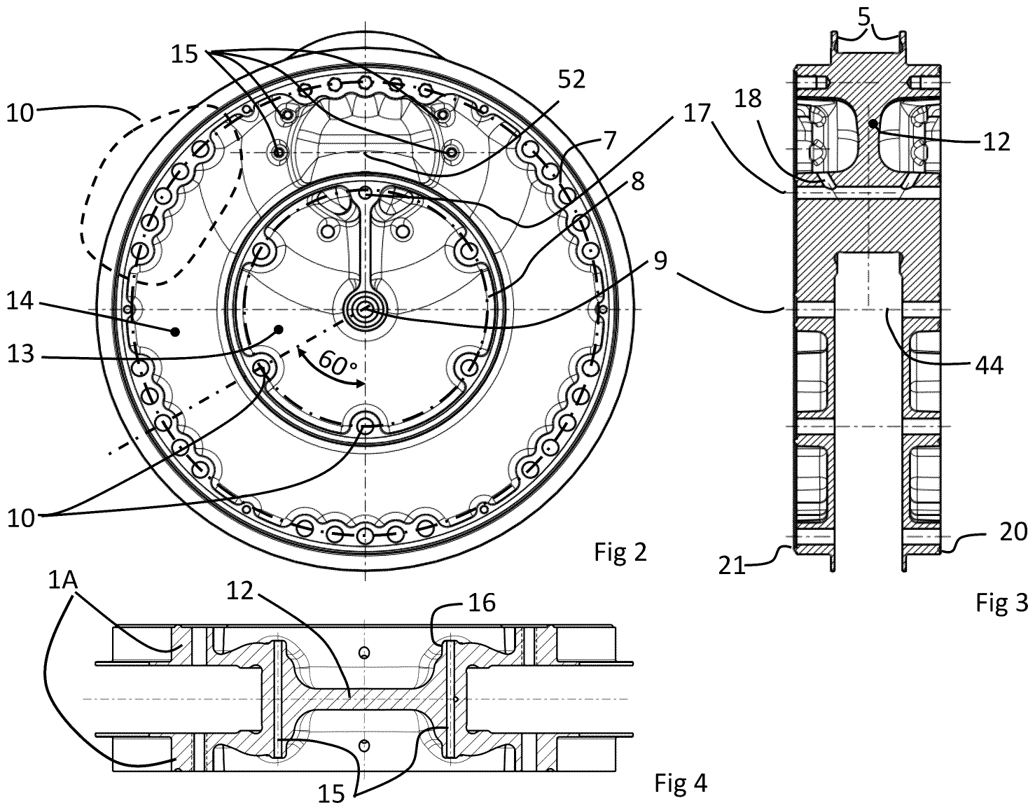

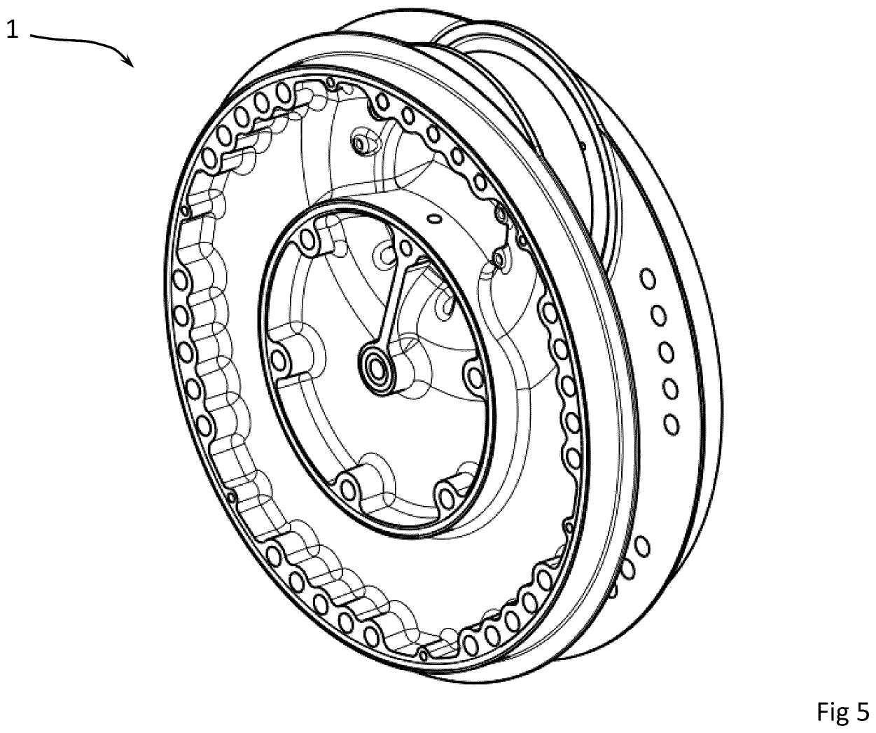

An exemplary embodiment of a crankshaft according to the innovation is shown in FIG. 1. In this regard, the crankshaft 2 is composed of crankshaft segments 1, which are fastened to one another in center 51 of the main bearings. The segments consist, essentially, of the crank pin 3 and the main bearing location 4, wherein the latter has a border 5 by means of which the bearing rings and roller bearing cages can be axially fixed in place. The segments, in the assembled state, form a cavity that is closed off, to a great extent, in the interior, which cavity is filled with oil, wherein the oil is filled in through bores and conducted to the large end bearing locations. At the ends of the segments, either further segments follow, or a crankshaft end piece 52 follows, which also closes off the cavity to a great extent. In the crankshaft segment, at the free end of the crankshaft, a central oil feed 53 is provided, through which the oil can be conducted into all the crankshaft segments. As an example, two main bearings 60 are shown at the right crankshaft end.

The crank web segment is provided, at both ends, with a total of 37 screw-connection positions toward the adjacent components. These screw connections are arranged on 2 partial circles, an outer one 7, an inner one 8, and once in the central position 9. The screws on the outer partial circle are arranged in six groups 10 offset from one another by 60°, with 5 screws, in each instance. On the inner partial circle there are 6 screw positions 11, which are also offset from one another by 60°. When screwing together the crankshaft segments according to FIG. 1, the segments are screwed together with an angle offset of 180° and 120° relative to one another, wherein the screw positions of crankshaft segments that lie against one another coincide. One of the six screw groups, in each instance, of each end of a crankshaft segment is arranged symmetrically relative to a plane that runs through the crankshaft axis and crank pin axis 52. The six groups, in each instance, of screw positions differ in terms of their embodiment in groups that consist of threaded holes and those that consist of passage holes for the screws. In the interior of the crank pin 3, there is a bulkhead wall 12.

The crankshaft segment is divided radially into an inner 13 and outer region 14, by means of which closed volumes are formed when they are screwed onto the adjacent elements. Both the inner and also the outer region of each segment, at both ends, is connected to the inner and outer region of the other end by means of bores. Four bores 15, which connect the outer regions to one another, are arranged outside of the bulkhead wall, in the thick-walled region of the crank pin. The exit openings of these bores pierce an exit hill 16. A further connection is produced by means of the continuous screw-connection bore 17, by way of connection bores 18. The inner region has two connection bores 19, which produce a connection, in the manner of the four connection bores 15, outside of the bulkhead wall.

The connection of the crankshaft segment to the adjacent elements takes place, in addition to the screw connection, with shape fit, by means of circumferential grooves 20 at one end and a circumferential elevation 21 at the other end. The grooves and elevations are structured in such a manner, in this regard, that they produce a connection that is free of play in the radial direction when they are screwed together with an element of the same type.

Along an imaginary plane between the crank pin axis and crankshaft axis, a rib runs within the inner, closed-off space, between a screw-connection point of the inner hole circle and the central screw position.

For axial positioning of a raceway and for guidance of a roller bearing cage, the crankshaft segment has borders 5.

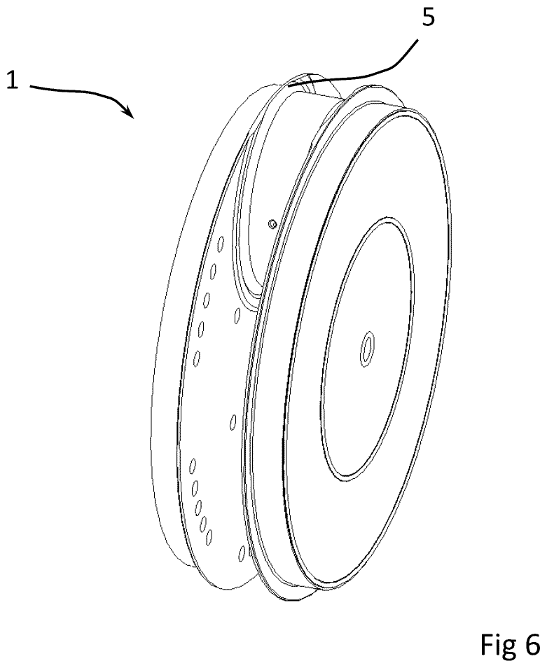

The border 5 is configured in such a manner, in the embodiment according to FIG. 6, that the outer expanse of the border does not go beyond the outer expanse of the crank web. In this regard, the crank web forms an envelope, the projection of which is not penetrated by the border, so as to guarantee axial mountability of the crankshaft in the tunnel. To state it differently, border 5 does not have any point, on its edge that is directed radial outward, which has a greater distance from the crankshaft axis than the crankshaft web itself.

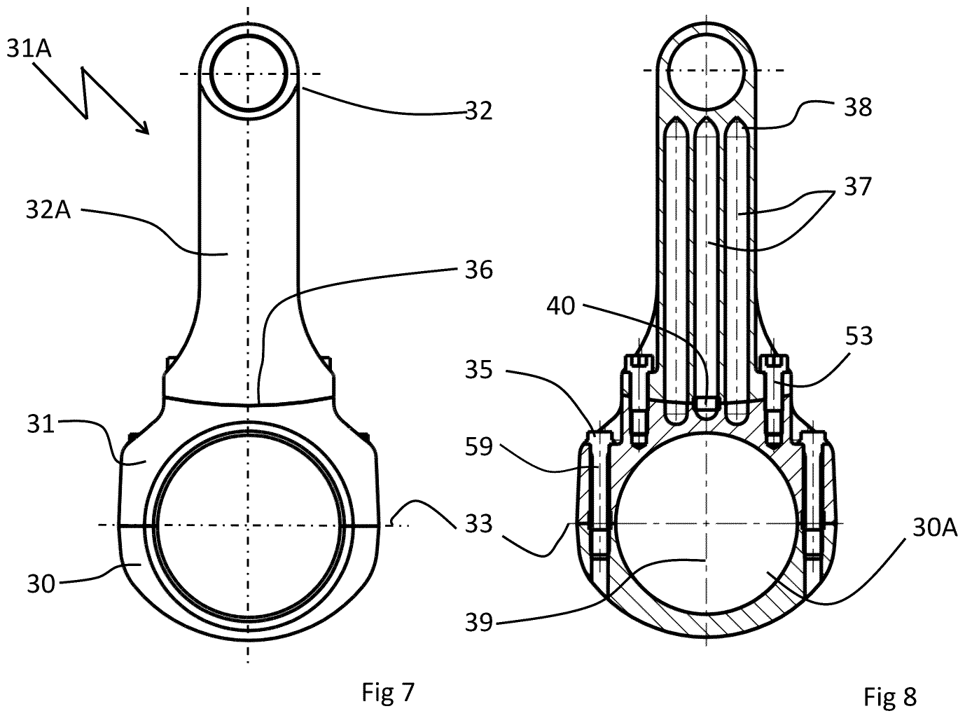

Since the border forms an axial contact surface for the connecting rod, a border without any interruption should be aimed at, so as to guarantee a continuous contact surface. The interrupted border, according to FIG. 7, however, offers a sufficient sliding surface, in the axial direction, for a rotating sliding surface of a connecting rod sliding on the crank pin 3.

For precise angle positioning, six pin holes 23 are introduced on the crankshaft segment, which holes allow a connection to adjacent elements in steps of 60°.

A further exemplary embodiment according to the invention is shown in FIG. 1; in this regard, during assembly of the segments, a further interior volume 7 that is essentially closed off is formed, which volume can also be used for passing oil on. The second interior volume makes it possible to pass on oil having a different pressure from the first interior volume. In the exemplary embodiment, the oil in the second interior volume is used for activation of a propeller adjustment, wherein for this purpose, a piston 8 having a return spring 9, in the crankshaft end that delivers power, passes the adjustment force on to the propeller by way of a rod 10. In this exemplary embodiment, as well, the oil feed takes place opposite to the crankshaft end that delivers power.

An embodiment of the connecting rod according to the invention is shown in FIGS. 7 and 8. FIG. 7 is a top view, in the crankshaft axis direction, and FIG. 8 is a sectional view through the connecting rod center, also seen in the crankshaft axis direction. The connecting rod consists of 3 main parts, the bearing lid 30, the center part 31, and the upper part 32. The bearing lid and the center part each contain one half of the large connecting rod eye, and the upper part contains the connecting rod shaft and the small connecting rod eye.

The separation 33 between the bearing lid and the center part conventionally takes place by means of a straight division, wherein the connection is produced by means of two screws 59. As is usual for boxer engines, the screws are arranged oriented with the head 35 in the direction of the piston. The separation 36 between the center part and the upper part runs in an arc shape, wherein here, too, the connection is produced with two screws 53. The shaft region of the upper part has facilitation bores 37. The facilitation bores have a radius 38. A centering ring 40 is provided between the center part and the upper part, concentric to the center axis of the connecting rod, which ring is arranged in a corresponding accommodation bore.

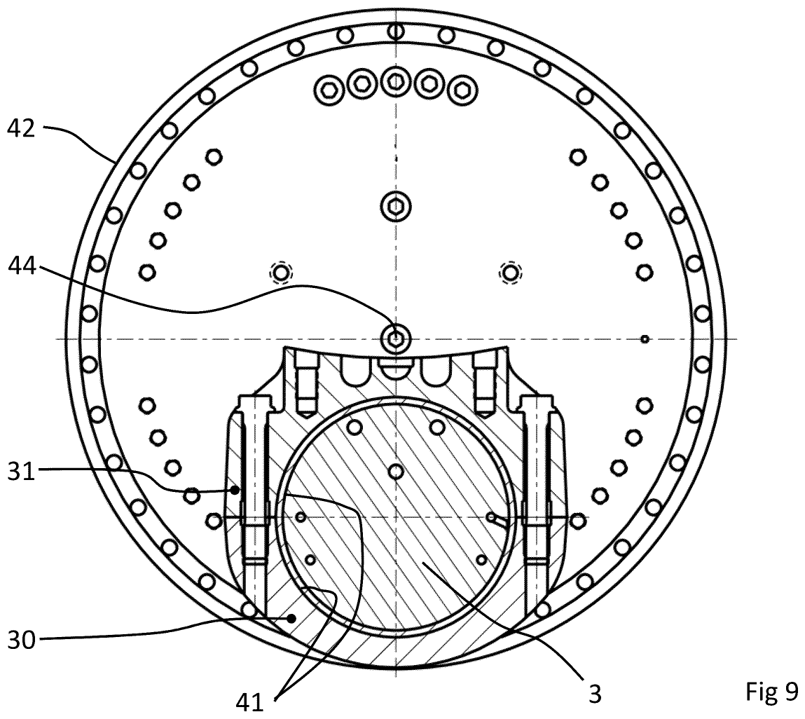

The pre-assembly of disk crankshaft, main bearing(s), center part and bearing lid, as well as the related screws and bearing shells for an exemplary crank pin according to the invention is shown in FIG. 9. In this regard, center part and bearing lid are mounted on a crank pin 3 with the bearing shells 41, wherein the center axis of the connecting rod 39 and the crankshaft axis 44 intersect, at least approximately. From the figure, it is evident that the pre-assembled components of the connecting rod are situated completely within the outer bearing cage diameter 42.

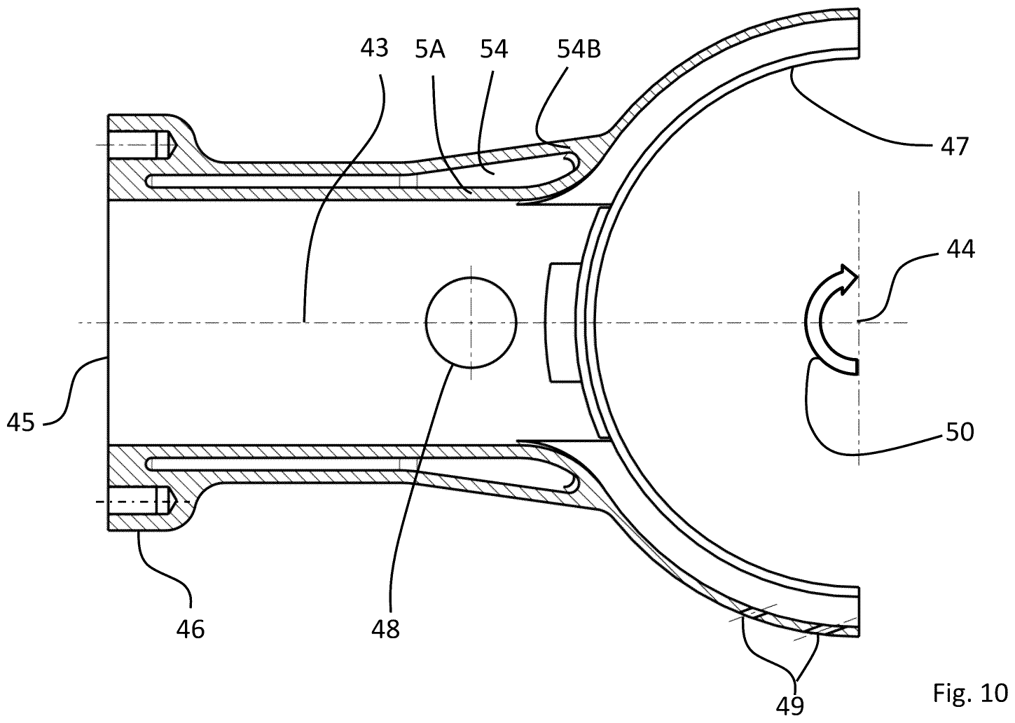

FIG. 10 shows a detail of the sectional view of the crankcase according to the invention as an exemplary embodiment. The section progression passes through a cylinder (arranged horizontally) having the cylinder axis 43, and show the region up to the crankshaft axis 44 in the crankshaft axis direction. The cylinder head is mounted, if applicable with a seal as an intermediate layer, on a surface 45, wherein screw shanks 46 are provided in the crankcase for fastening. Raceways 47 for the main bearings are built into the housing, one of which can be seen in the figure. The cylinder is provided with a water agent mantle 54, which is delimited, toward the inside, essentially by means of the cylinder wall, and has a wall structure toward the outside, which produces a connection between the screw shanks for the cylinder head attachment and the main bearing bracket. The crankcase possesses through bores 48 for installation of the piston pins. For oil separation, oil outflow bores 49 are provided, wherein these are arranged in such a manner that their opening toward the inside crankcase volume is opposite to the direction of rotation 50 of the crankshaft.

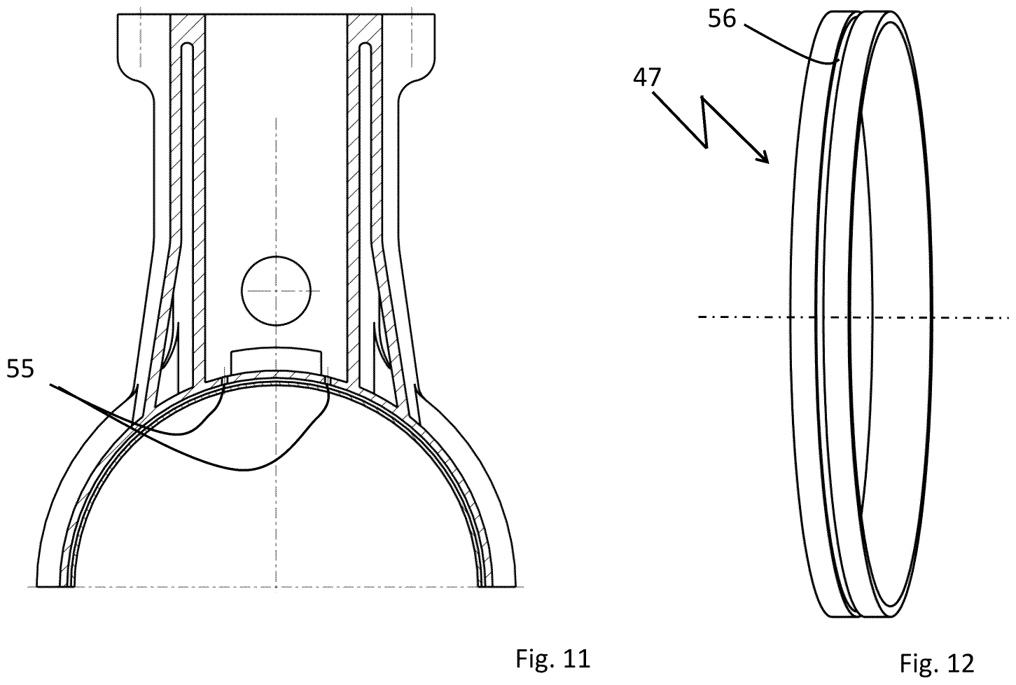

FIG. 11 also shows a sectional view, which runs parallel to and offset from the view of FIG. 10. In this regard, the center of a main bearing is intersected. In this regard, two oil injection bores 55 for piston cooling and the circumferential oil distribution groove 56 in the raceway 47 can be seen.

FIG. 12 shows a raceway 47 in a perspective view, with the oil distribution groove 56.

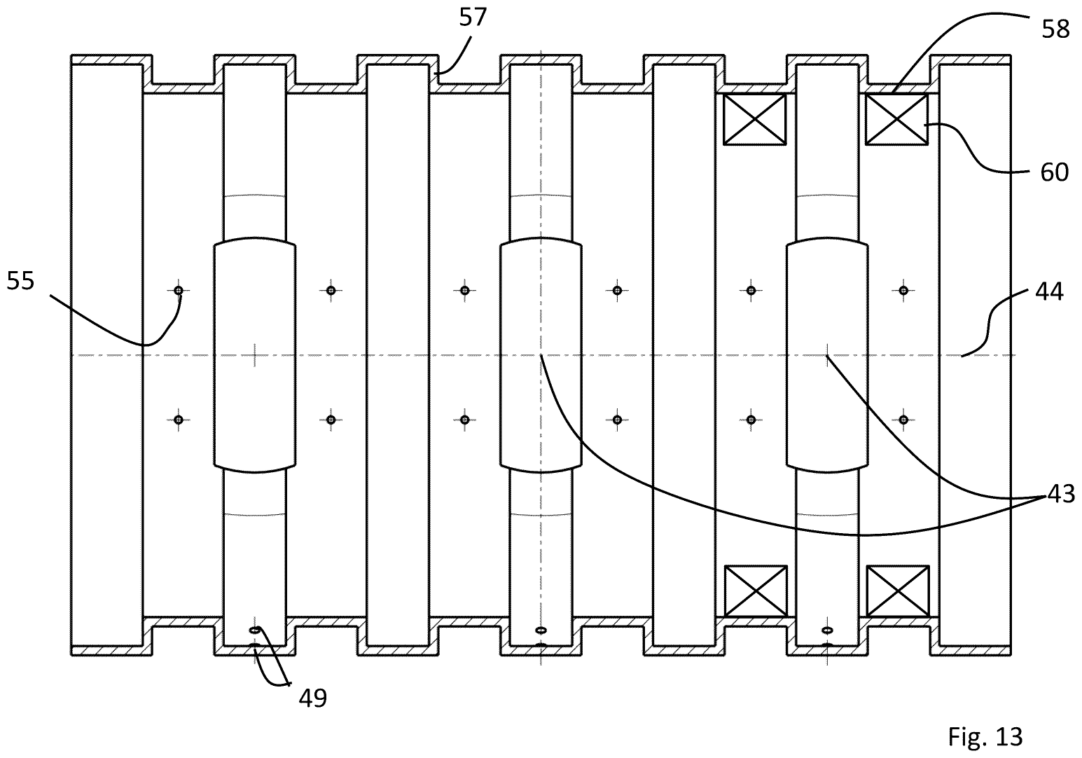

FIG. 13 shows a section through a crankcase according to the invention, in a design for boxer engines, without raceways, which section runs through the crankshaft axis 44 and perpendicular to the cylinder axes 43. Using this section, the corrugated pipe structure 57 of the crankcase, about the crankshaft axis, becomes evident. Four oil injection bores 55 are provided per cylinder. The oil discharge takes place through bores 49 in the lower region of the crankcase. In the corrugated structure, the small diameters 58 serve as a bearing seat for the main bearings 60. The widened part between the bearing seats allows sufficient free space for the connecting rods.

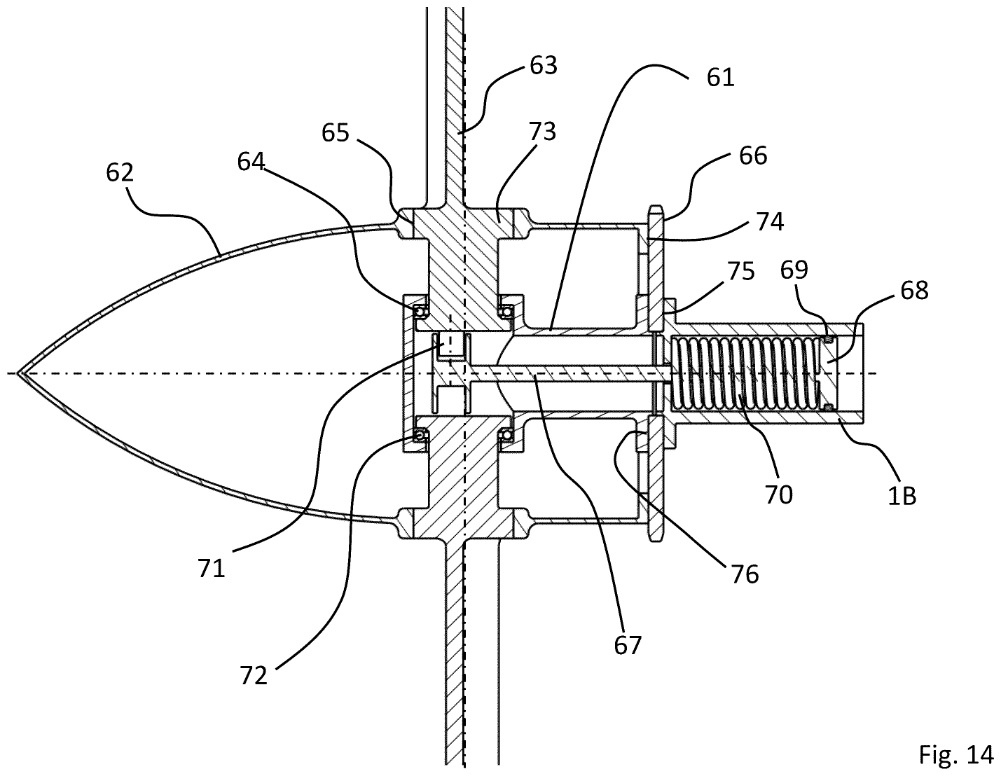

FIG. 14, in greatly simplified form, shows the connection of the propeller to the crankshaft. For clarification, a sectional view is used here, the section plane of which passes through the axis of rotation of the propeller/crankshaft and the setting axis of the propeller blades. In this regard, the propeller hub 61 is shown, with cowling 62, two propeller blades 63, the mounting of the propeller blades in the hub 64, the mounting of the propeller blades in the cowling 65, the starter ring 66, the crankshaft end 1B, the adjustment shaft 67 for the propeller blade adjustment, the hydraulic adjusting piston 68, its seal 69, the reset spring 70. The section runs through the axes of rotation of propeller and propeller adjustment.

It is understood that the components shown can also be structured in multiple parts, but this is not included in the drawing. The structure of the hub corresponds, to a great extent, to the state of the art for hydraulic adjustable propellers, in which an adjustment shaft that is axially displaceable in the propeller axis direction transfers the adjustment forces from a hydraulic adjustment piston having a reset spring to cams 71. In deviation from the state of the art, in this regard, is the placement of the hydraulic piston in the front crankshaft end instead of the usual arrangement as a part of the propeller hub. The mounting of the propeller blades within the hub takes place by means of axial ball bearings 72. Additional mounting of the propeller blades takes place at the bearing locations of the cowling. In the region of the bearing location, the propeller blades are provided with a cylindrical section 73. The cowling is fastened to the starter ring at the position 74. The starter ring itself is connected to the crankshaft end at the location 75, and on the opposite side, the hub is connected to the starter ring at the location 76.

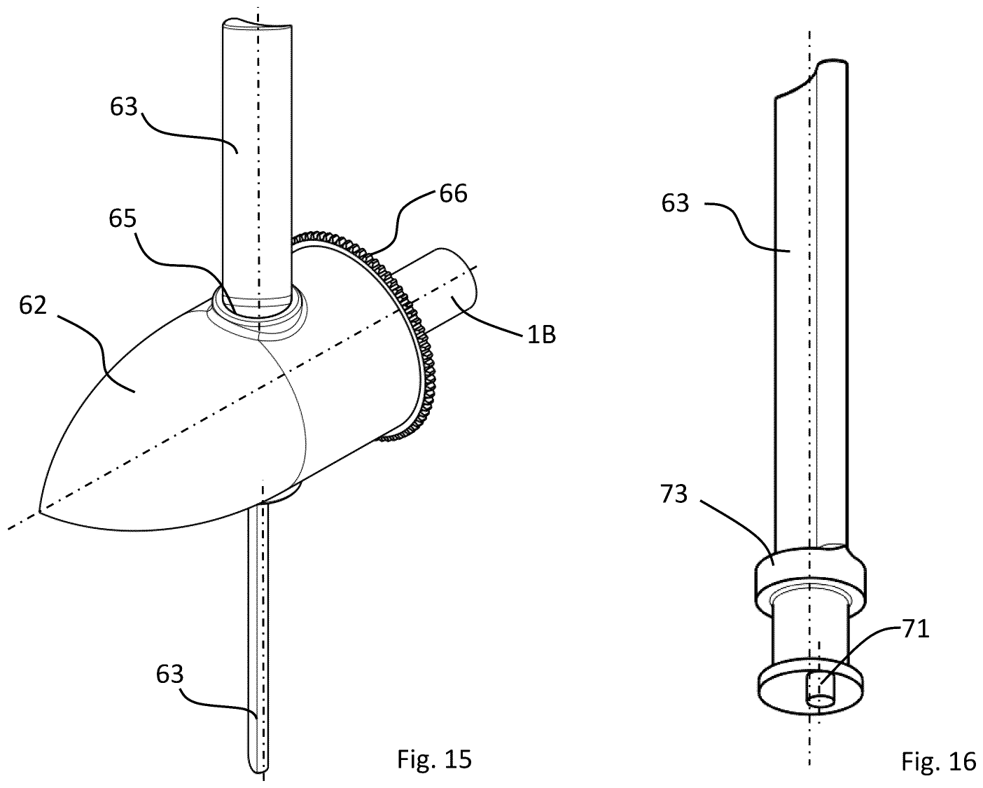

FIG. 15 shows a perspective top view of the cowling, with the propeller blades and the bearing locations. Likewise, the starter ring can be seen, in part; the cowling is attached to it.

FIG. 16 shows a propeller blade with the cylindrical bearing location to the cowling and the cam for blade adjustment.

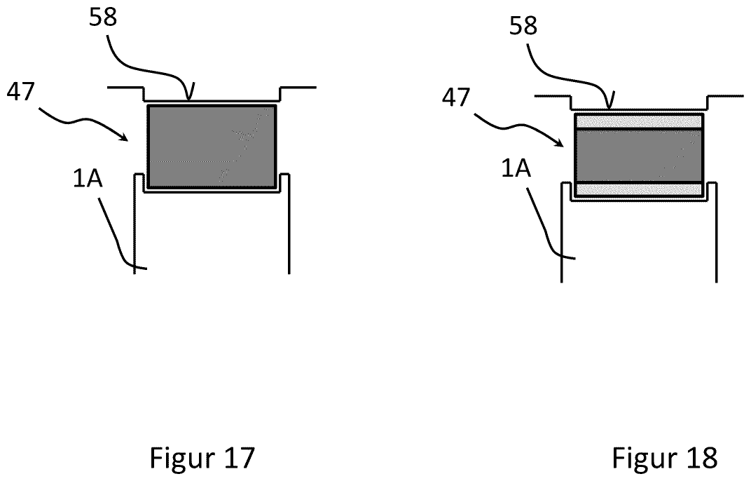

FIGS. 17 and 18 show a further slide ring according to the invention, which is configured as a hybrid ring. The hybrid ring has two sliding surfaces, in this regard; an inner sliding surface and an outer sliding surface. This allows the bearing ring, in the best case, to rotate at half the speed of rotation of the crankshaft. The bearing ring thereby forms an outer slide bearing relative to the crankcase and an inner slide bearing relative to the crank pin. It is immediately evident that the speed of rotation of the bearing ring can vary between 0 and the speed of rotation of the crankshaft, depending on which of the two sliding surfaces is functioning as a slide bearing.

The loose bearing ring is made of a hybrid material, in a further embodiment, so as to master the sliding properties, on the one hand, and the temperature expansion, on the other hand. Since the surface pressures in the housing is very slight, it can be assumed, for example, that the outer part of the rings is made of steel (or the like) with a DLC coating. This steel ring is structured in such a manner that in the installed state, it has a finished dimension with the inner ring that allows the corresponding play with the housing to be set.

The bearing surfaces between housing/hybrid ring and hybrid ring/crank web are supplied with pressure oil. The cross-sectional structure of the hybrid ring is structured in such a manner that it is adapted to the stresses. The hybrid ring can run directly on the crank web, on a separate ring. In the event that this separate ring is structured as a sliding material, the hybrid ring can be made entirely of steel. Depending on the stress, it can be hardened and/or coated with DLC.

The hybrid ring can also be structured in such a manner that the inner part is made of steel, and the outer part is made of slide bearing material (for example Brass (Ms.)).

FIGS. 17 and 18 once again show a bearing ring according to the invention, the raceway 47, in cross-section. The raceway 47 has two sliding surfaces; an inner sliding surface that forms a friction pairing with the crank web 1A, and an outer sliding surface that forms a friction pairing with the bearing seat 58 of the crankcase.

The bearing ring 58 shown in FIG. 18 is structured in multiple parts, in this regard. In this regard, it has a core composed of a first material, such as steel or aluminum, for example, and two sliding surfaces composed of a further material. Thus, the outer and the inner sliding surface can also consist of a very hard material, for example, such as a DLC coating, or, alternatively, also of a very soft material, such as, for example, a brass or red brass alloy, as described previously. It is understood that the selection of the material pairings advantageously takes place taking into consideration the aspect of the most uniform possible heat expansion between the crank web 1A, the bearing seat 58, i.e., the crankcase and the raceway 47.

### REFERENCE SYMBOL LIST

1 crankshaft segment
1A crank web
1B crankshaft end piece
2 crankshaft
3 crank pin
4 main bearing location
4A main bearing surface
5 border
6 roller bearing cage
7 outer partial circle
8 inner partial circle
9 central position
10 screw group
11 screw position
12 bulkhead wall
13 inner region
14 outer region
15 bores
16 exit hill
17 screw-connection bore
18 connection bore
20 circumferential groove
21 circumferential elevation
23 pin holes
30 bearing lid
31A divided connecting rod
31 center part
32 upper part
32A connecting rod bar
33 division
34 screws
35 screw head
36 division
37 facilitation bore
38 radius
39 center axis
40 centering ring
41 bearing shell
42 bearing cage diameter
43 cylinder axis
44 crankshaft axis
45 surface
46 screw shank
47 raceway
48 bore
49 oil outflow bore
50 direction of rotation
51 center of main bearing(s)
52 crank pin
53 screws
54 water mantle
54A cylinder wall
54B wall structure
55 oil injection bores
56 oil distribution groove
57 corrugated pipe structure
58 bearing seat
59 screws
60 main bearing(s)
61 propeller hub
62 cowling
63 propeller blade
64 mounting of propeller blade hub
65 mounting of propeller blade cowling
66 starter ring
67 adjustment shaft
68 hydraulic adjustment piston
69 seal
70 reset spring
71 cam
72 axial ball bearing
73 cylindrical section
74 attachment of cowling starter ring
75 attachment of starter ring crankshaft
76 attachment of hub crankshaft

Accordingly, while at least one embodiment of the present invention have been shown and described, it is to be understood that many changes and modifications may be made thereunto without departing from the spirit and scope of the invention as defined in the appended claims.

1. A crankshaft segment (1) comprising:
at least one disk-shaped crank web (1A), arranged with rotation symmetry relative to a crankshaft axis (44) and carrying a main bearing surface (4A) that rotates around said crankshaft axis (44), and
a crank pin (3) that is arranged eccentric to the crankshaft axis (44) and extends parallel to the crankshaft axis (44), wherein a depression (22) that is set back axially in the direction of the crankshaft axis (44) is provided on the side of the crank web (1A) that faces away from the crank pin (3) and/or that screw-connection openings (17) are arranged in screw groups (10), in the crank web (1A), with a rotation symmetry of 60°, wherein one of the screw groups (10) is arranged at the level of the crank pin (3).

2. The crankshaft segment (1) according to claim 1, wherein a further crank web (1A) that is also configured in disk shape and arranged with rotation symmetry relative to the crankshaft axis (44), and also carries a main bearing surface (4A) that rotates around the crankshaft axis (44), wherein the crank pin (3) is arranged between two crank webs (1A), viewed along the crankshaft axis (44).

3. The crankshaft segment (1) according to claim 2, wherein a depression (22) that is set back axially, in the direction of the crankshaft axis (44), is also provided on the side of the further crank web (1A) that faces away from the crank pin (3).

4. The crankshaft segment (1) according to claim 1, wherein the crank pin (3) has a crank pin axis (52) that extends parallel to the crankshaft axis (44).

5. The crankshaft segment (1) according to claim 4, wherein the crank pin axis (52) is arranged radially within the main bearing surface (4A).

6. The crankshaft segment (1) according to claim 4, wherein the screw-connection openings (17) of the screw groups (10) are arranged on an outer circle (7) within which the crank pin axis (52) lies.

7. The crankshaft segment (1) according to claim 6, wherein screw-connection openings (17) having a rotation symmetry of 60° are arranged on an inner circle (8) that lies within the crank pin axis (52) and/or that a screw-connection opening (17) is arranged on the crankshaft axis (44).

8. The crankshaft segment (1) according to claim 1, wherein the border (5) that projects radially beyond the main bearing surface (4A) is provided on the side of the main bearing surface (4A) that faces the crank pin (3).

9. A crankshaft (2) comprising at least one crankshaft segment (1) according to claim 1 as well as two crankshaft end pieces (1B) arranged on both sides of the crankshaft segment (1), of which pieces at least one carries a power take-off shaft (1B).

10. The crankshaft (2) according to claim 9, wherein at least one of the crankshaft end pieces (1) closes off the depression (22) to form a cavity (22A).

11. The crankshaft (2) according to claim 9, wherein multiple crankshaft segments (1), are arranged between the two crankshaft end pieces (1A), wherein at least one depression (22) of a crankshaft segment (1) is closed off by a crank web (1A) of a further crankshaft segment (1), to form a cavity (22A).

12. The crankshaft (2) according to claim 9, wherein the main bearing surface (4A) of the crankshaft segment (1) represents only a part of a main bearing location (4), and a further part is formed by a crankshaft end piece (1B) or by the further crankshaft segment (1).

13. The crankshaft (2) according to claim 9, wherein at least two crankshaft segments (1) are screwed together by way of screws having screw heads and screw shafts, wherein the screws, at the level of at least one, preferably all of the crank pins (3) point in the direction of the crank pin (3) with their screw shafts.

14. A divided connecting rod (31A), wherein a connecting rod eye (30A) composed of a bearing lid (30) and a center part (31), both of which are connected to form the connecting rod eye (30A), as well as by an upper part (32) that forms a connecting rod bar (32A), which part is connected to the center part (31).

15. The connecting rod (31A) according to claim 14, wherein the bearing lid (30) and the center part (31) and/or the center part (31) and the upper part (32) are screwed onto one another.

16. The connecting rod (31A) according to claim 14, wherein the connecting rod (31A) has a center axis (39).

17. The connecting rod (31A) according to claim 16, wherein a parting surface (36) is provided between the center part (31) and the upper part (32), which surface approaches the bearing lid (30) in a constant progression toward the center axis (39).

18. The connecting rod (31A) according to claim 16, wherein the upper part (32) widens toward the center part (31), in a plane that contains the center axis (39) and the connecting rod eye (30A).

19. An assembly-ready arrangement of a crankshaft (2), configured as a disk crankshaft and comprising disk-shaped crank webs (1A) that are arranged with rotation symmetry relative to a crankshaft axis (44) and carry a main bearing surface (4A) that rotates around a crankshaft axis (44), and crank pins (3) that are arranged eccentric to the crankshaft axis (44) and extend parallel to the crankshaft axis (44), and having bearings (42A) that are set onto the crank webs (1A), which bearings have a bearing outside diameter (42), as well as connecting rod eyes (30A) that are arranged on the crank pins, wherein the connecting rod eyes (30A) are arranged radially within a cylinder surface that spans the bearing outside diameters (42).

20. The arrangement according to claim 19, wherein at least one of the connecting rod eyes (30A) is a connecting rod eye (30A) of the connecting rod (31A).

21. The arrangement according to claim 19, wherein the crankshaft (2) is a crankshaft (2) comprising at least one crankshaft segment (1) as well as two crankshaft end pieces (1B) arranged on both sides of the crankshaft segment (1), of which pieces at least one carries a power take-off shaft (1B).

22-30. (canceled)
